(19) United States
(12) Patent Application Publication
(10) Pub. No.: US 2013/0330572 A1
(43) Pub. Date: Dec. 12, 2013

(54) WINDSCREEN WIPER DEVICE

(71) Applicants: Klaus Staschko, Taunusstein (DE); Juri Magomajew, Solingen (DE)

(72) Inventors: Klaus Staschko, Taunusstein (DE); Juri Magomajew, Solingen (DE)

(21) Appl. No.: 13/822,158

(22) PCT Filed: May 27, 2011
(86) PCT No.: PCT/EP2011/058762

§ 371 Date: Aug. 22, 2013

(30) Foreign Application Priority Data
Sep. 9, 2010 (DE) 10 2010 040 469.1

(51) Int. Cl. F16C 33/10; C25D 7/10

(52) U.S. Cl. CPC F16C 33/1095; C25D 7/10
USPC 428/647; 428/646; 205/183

(57) ABSTRACT

The invention relates to a layered composite material for sliding elements, comprising a base layer, applied to the surface of a sliding element, made of an alloy comprising copper or aluminum and a sliding layer situated over said layer, wherein the sliding layer comprises 90.99.6 wt % of tin or tin alloy having a tin ratio of greater than 60 wt % and 0.2-6 wt % solid lubricant particles having a Mohs hardness of ≦3 and a particle size of ≦10 μm. The invention further relates to the production of said layered composite material and to use thereof for sliding bearings.

The invention relates to a layered composite material for sliding elements, in particular sliding bearings, comprising a base layer, applied to the surface of a sliding element, made of an alloy containing copper or aluminium and a sliding layer arranged above said layer, wherein the sliding layer comprises 90-99.6 wt.-% tin or tin alloy having a tin proportion of more than 60 wt.-% and 0.2-6 wt.-% solid lubricant particles having a Mohs hardness of 3 and a particle size of 10 μm. The invention furthermore relates to a method for producing this layered composite material as well as the use of same.

Sliding elements which are exposed to mechanical stresses in the form of friction, for example sliding bearings for combustion engines, must have good sliding properties, sufficient hardness, low seizing tendency and a sufficient wear resistance as well as high corrosion resistance. For this, sliding elements, in particular their sliding surfaces, can be provided with sliding coatings made of metal or metal alloys. On the one hand, these coatings should have a sufficient ductility and display a low embrittlement tendency, in particular under load and at high temperatures, and, on the other hand, should have a high internal strength in order to withstand the loads.

In DE 197 54 221 A1, a layered composite material is described, the electroplated sliding layer of which, irrespective of the copper content, displays no embrittlement even at higher temperatures, wherein the layered composite material has a sliding layer having 8-30 wt.-% copper, 60-97 wt.-% tin and 0.5-10 wt.-% cobalt.

In DE 197 28 777 A1, a layered composite material for sliding bearings is described, the sliding layer of which consists of a lead-free alloy containing tin and copper, wherein the copper proportion is 3 to 20 wt.-% and the tin proportion is 70-97 wt.-%. To improve the wear resistance of this sliding layer, it is proposed to incorporate hard-material particles made of aluminium oxide, silicon nitride, diamond, titanium dioxide and/or silicon carbide into the sliding layer.

In DE 10 2009 019 601 B3, a layered composite material for sliding elements is described, comprising a base layer, applied to the surface of a sliding element, made of a copper or aluminium alloy and a sliding layer applied directly to the base layer, characterized in that the sliding layer comprises 85-99.5 vol.-% copper or copper alloy and 0.5-15 vol.-% solid lubricant particles having a Mohs hardness of ≦2 and a particle size of ≦10 μm and contains no hard-material particles having a Mohs hardness of ≧9.

Sliding bearings with a high loadability and wear resistance can be produced with the above-described layered composite materials. However, the sliding properties of these layered composite materials are still in need of improvement.

In principle, sliding layers made of tin or tin alloys have the advantage over sliding layers made of copper and copper alloys that they have very good sliding properties because of their lower hardness and higher ductility. On the other hand, the strength of sliding layers made of tin or tin alloys is insufficient for some applications. In turn, the wear resistance of certain sliding layers can be increased with the solution proposed in DE 197 28 777 A1 of incorporating hard-material particles, but the sliding properties and the strength are still in need of improvement.

The object of the present invention is therefore to provide a layered composite material for sliding elements which has excellent sliding properties and, at the same time, high strength and hardness as well as a good corrosion resistance and low seizing tendency.

According to the invention, this object is achieved by a layered composite material for sliding elements comprising a base layer, applied to the surface of a sliding element, made of an alloy containing copper or aluminium and a sliding layer arranged above said layer, wherein the sliding layer comprises 90-99.6 wt.-% tin or tin alloy having a tin proportion of more than 60 wt.-% and 0.2-6 wt.-% solid lubricant particles having a Mohs hardness of ≦3 and a particle size of ≦10 μm.

This object is further achieved by a method for producing a layered composite material for sliding elements, in which

(a) a sliding element comprising a base layer, applied to the surface of the sliding element, made of an alloy containing copper or aluminium and optionally a metallic diffusion-barrier layer arranged thereon is introduced into an aqueous electrolyte which contains tin ions, solid lubricant particles having a Mohs hardness of ≦3 and a particle size of ≦10 μm and optionally hard-material particles having a Mohs hardness of ≧8 and a particle size of ≦5 μm and

(b) a sliding layer which comprises 90-99.6 wt.-% tin or tin alloy having a tin proportion of more than 60 wt.-%, 0.2-6 wt.-% solid lubricant particles having a Mohs hardness of ≦3 and a particle size of ≦10 μm and optionally 0.2-4 wt.-% hard-material particles having a Mohs hardness of ≧8 and a particle size of ≦5 μm is electrodeposited.

Because of the lower hardness of sliding layers made of tin compared with those made of copper, it was to be assumed that sliding layers made of tin would not need further support for the sliding properties, for example by solid lubricant particles having low hardness. However, it was surprisingly found within the framework of the present invention that the hardness and strength of the tin layer can be increased by incorporating solid lubricant particles into sliding layers made of tin or tin alloys having a high tin proportion of more than 60 wt.-%, and in addition the sliding capacity is improved. The surprising increase in strength makes it possible to make the good sliding properties of tin layers useful for applications in which an increased strength of the sliding layer is necessary. In addition, the layered composite material according to the invention has a high corrosion resistance, a high hardness and a low seizing tendency.

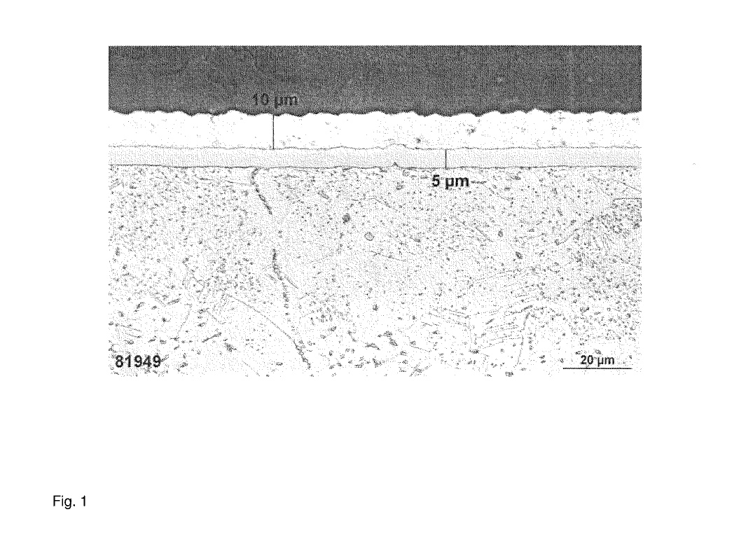

FIG. 1 shows a light microscope image of the layered composite material according to the invention on which the base layer made of a copper-nickel-silicon alloy can be seen at the bottom, above that a nickel layer and, above that, a sliding layer made of tin with SnS₂ particles.

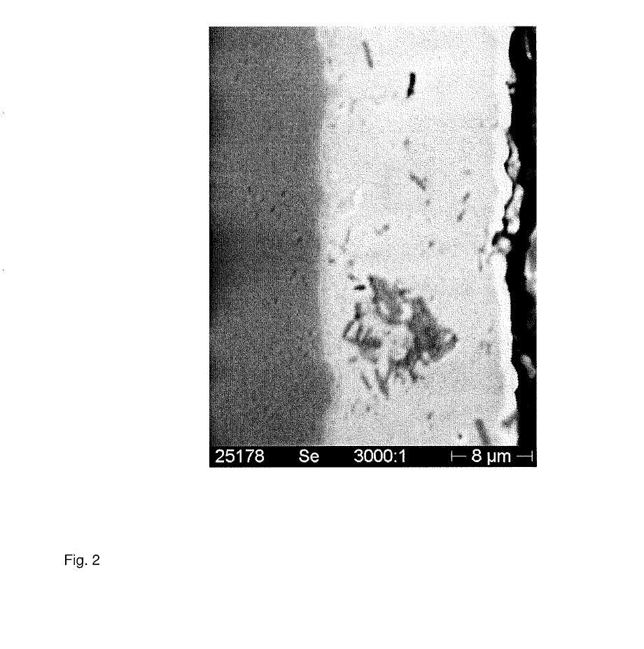

FIG. 2 shows a scanning electron microscope image of the layered composite material according to the invention on which the base layer made of a copper-nickel-silicon alloy can be seen on the left and, next to that, on the right, the sliding layer, arranged on the base layer, made of tin with graphite and SnS₂ particles.

By sliding elements are meant, within the meaning of the invention, elements which have a sliding surface for sliding contact with a counterface. Sliding elements preferred according to the invention are sliding bearings, bushings, cylinders, pistons, pins, seals, valves and pressure cylinders. Sliding elements particularly preferred according to the invention are sliding bearings, in particular sliding bearings for combustion engines, for example crankshaft bearings, camshaft bearings or connecting rod bearings.

As a rule, a sliding bearing has the following layer structure: support made of steel (material of the sliding bearing), base or bearing metal layer (so-called substrate), optionally a dam or diffusion-barrier layer and a sliding layer made of metal or a metal alloy. The bearing metal layer can be for example a copper alloy layer, in particular a sintered or cast copper alloy layer. The sliding layer can for example be electroplated.

Because of the extremely good sliding properties of the layered composite material according to the invention, it is suitable in particular for sliding bearings in combustion engines in which insufficient lubrication can occur, e.g. in modern motor vehicles with automatic start-stop systems, as here the engine is often switched off when the bearings and lubricants are still cold if operated over short distances.

The base layer of the layered composite material according to the invention consists of an alloy containing copper or aluminium. Preferred alloys are copper-aluminium, copper-aluminium-iron, copper-zinc-aluminium, copper-tin, copper-zinc, copper-zinc-silicon, copper-nickel-silicon, copper-tin-nickel, aluminium-tin, aluminium-zinc and aluminium-silicon alloys. The layer thickness of the base layer is preferably 300-600 μm. The base layer can be cast, or applied chemically or galvanically (electrochemically).

The sliding layer of the layered composite material according to the invention, which is applied electrochemically, comprises 90.0-99.6 wt.-% tin or tin alloy, wherein the tin proportion of the tin alloy is more than 60 wt.-%, and 0.2-6 wt.-% solid lubricant particles, in each case relative to the total mass of the sliding layer. The sliding layer preferably comprises 91-99.3 wt.-% tin or tin alloy having a tin proportion of more than 60 wt.-% and 0.5-5 wt.-% solid lubricant particles, particularly preferred are 93-99.0 wt.-% tin or tin alloy having a tin proportion of more than 60 wt.-% and 0.8-3 wt.-% solid lubricant particles. Any remaining portion can be formed among other things by hard-material particles, which are described in more detail below. These proportions by weight have proved to be particularly advantageous for a good balance between strength and sliding capacity of the layered composite material according to the invention.

In a particularly preferred embodiment, the sliding layer comprises tin. Where tin alloys are used, of these those with a proportion by weight of tin of more than 80 wt.-%, in particular more than 95 wt.-%, are in turn preferred. Suitable tin alloys are in particular tin-nickel, tin-antimony, tin-bismuth, tin-iron, tin-lead, tin-zinc and tin-silver alloys. The sliding layer further preferably comprises no tin-copper alloy.

Most preferably, the sliding layer of the layered composite material according to the invention consists of tin or a tin alloy having a tin proportion of more than 60 wt.-%, the solid lubricant particles and optionally hard-material particles, in each case having the quantities and sizes of the solid lubricant particles and optionally hard-material particles mentioned above. In one embodiment, the sliding layer of the layered composite material according to the invention can thus consist of 94-99.8 wt.-% tin or tin alloy, wherein the tin alloy has a tin proportion of more than 60 wt.-%, and 0.2-6 wt.-% solid lubricant particles having a Mohs hardness of ≦3 and a particle size of ≦10 μm and, in another embodiment, the sliding layer can consist of 90-99.6 wt.-% tin or tin alloy, wherein the tin alloy has a tin proportion of more than 60 wt.-%, 0.2-6 wt.-% solid lubricant particles having a Mohs hardness of ≦3 and a particle size of ≦10 μm and 0.2-4 wt.-% hard-material particles having a Mohs hardness of ≧8 and a particle size of ≦5 μm.

The solid lubricant particles contained in the sliding layer are particles which develop a lubricating effect, thus an effect that improves the sliding properties, in sliding operation between the sliding partners, for which among other things a low hardness of the particles is necessary. In principle particles having a hardness according to Mohs of up to approximately 3 are suitable. The sliding layer according to the invention therefore contains solid lubricant particles having a Mohs hardness of ≦3, so-called soft particles. The sliding layer preferably contains solid lubricant particles having a Mohs hardness of ≦2.

The Mohs hardness is determined according to the hardness test according to Mohs known in the prior art in which the hardness is determined by the scratch resistance of one material to another. The Mohs scale in which talc has the hardness 1, gypsum the hardness 2, calcite the hardness 3, fluorite the hardness 4, apatite the hardness 5, feldspar the hardness 6, quartz the hardness 7, topaz the hardness 8, corundum the hardness 9 and diamond the hardness 10 was established via this scratch resistance or scratch hardness. If a test material cannot be scratched by a material of the Mohs scale, its hardness is greater than or equal to that of the material of the scale. If a test material can be scratched by a material of the scale, it has a lower hardness. The same hardness is present if a test material does not scratch one of the listed materials of the Mohs scale and also cannot be scratched by it. If a test material scratches a scale material and is itself not scratched by the material in question but only by the next highest material in the scale, the hardness of the test material lies between the hardnesses of the two materials of the scale, which is indicated by the decimal place 5.

Graphite, metal sulfides, hexagonal boron nitride, polymers and mixtures thereof are preferred as solid lubricant particles. These materials have proved to be particularly suitable for the sliding layer according to the invention with regard to the sliding properties with, at the same time, high hardness and loadability of the layered composite material.

Preferred metal sulfides are iron sulfide, cobalt sulfide, copper sulfide, copper iron sulfide, manganese sulfide, molybdenum sulfide, silver sulfide, bismuth sulfide, tungsten sulfide, tin sulfide and/or zinc sulfide. By the named metal sulfides are meant mono- and disulfides, sulfides of defined oxidation states of the metals and mixtures of the individual oxidation states of the metals, for example iron sulfide (FeS (iron(II)sulfide) and/or FeS₂ (iron(II)disulfide)), cobalt sulfide (CoS and/or CoS₂ (cobalt disulfide)), copper sulfide (CuS (copper(II)sulfide) and/or Cu₂S (copper(I)sulfide)), copper iron sulfide (CuFeS₂), manganese sulfide (MnS), molybdenum sulfide (molybdenum(II)sulfide (MoS) and/or molybdenum(IV)sulfide (MoS₂)), silver sulfide (Ag₂S), bismuth sulfide (Bi₂S₃), tungsten sulfide (tungsten(IV)sulfide (WS₂)), tin sulfide (SnS (tin(II)sulfide), SnS₂ (tin(II)disulfide) and/or Sn₂S₃ (mixed tin sulfide made of SnS and SnS₂)) and zinc sulfide (ZnS). In particular, particles made of polytetrafluoroethylene, polyvinylidene fluoride, polyvinyl chloride, polypropylene, polyethylene and similar polymers are suitable as polymer particles.

In a particularly preferred embodiment, the sliding layer of the layered composite material according to the invention contains tin(IV)sulfide (SnS₂) particles, graphite particles and/or molybdenum(IV)sulfide (MoS₂) particles, in particular a combination of tin(IV)sulfide particles and graphite particles, of tin(IV)sulfide particles and molybdenum(IV)sulfide particles or of graphite particles and molybdenum(IV)sulfide particles as solid lubricant particles.

The particle size of the solid lubricant particles is at most 10 μm, preferably at most 8 μm, in particular 0.1 to 6 μm, as excellent sliding properties can thus be obtained, while the strength of the sliding layer remains high.

The sliding layer preferably has a layer thickness of 2-18 μm, in particular 3-13 μm. With these thicknesses, a very good structural strength of the particle-containing sliding layer can be achieved.

In a further preferred embodiment, the sliding layer of the layered composite material according to the invention additionally contains hard-material particles having a Mohs hardness of ≧8, in particular ≧9, having a particle size of ≦5 μm, as the wear resistance of the sliding layer can thus additionally be improved. The proportion of the hard-material particles is preferably 0.2-4 wt.-%, preferably 0.3-3.5 wt.-%, in particular 0.4-3 wt.-%. In these quantities, an optimum ratio between wear resistance and sliding capacity can be achieved together with the solid lubricant particles and the named particle sizes, wherein the improved strength of the sliding layer is maintained. Preferably, tungsten carbide, chromium carbide, aluminium oxide, silicon carbide, silicon nitride, cubic boron nitride, boron carbide and/or diamond are used as hard-material particles.

The particle size of the hard-material particles preferably lies in the range of from 0.1 to 5 μm, in particular in the range of from 0.2 to 3 μm. Diamonds, and of these in turn those with a size in the range of from 0.2 to 0.5 μm, are particularly suitable as solid particles. Furthermore, aluminium oxide particles having a particle size in the range of from approximately 0.2 to 5 μm are preferred. Embedded diamond particles can be formed from mono- and/or polycrystalline diamond. The solid lubricant particles and the hard-material particles can in each case independently of each other be mixtures of particles of different types of material in combination.

The sliding layer of the layered composite material according to the invention can be applied directly to the base layer, with the result that there is no further layer between base layer and sliding layer or there can be at least one metallic diffusion-barrier layer, preferably made of cobalt, nickel, a tin-nickel alloy or a combination of a nickel layer and a tin-nickel alloy layer, between base layer and sliding layer. The diffusion-barrier layer limits the diffusion of metal atoms between base layer and sliding layer and in this way prevents changes in the properties of the layered composite material, in particular when a correspondingly coated sliding element is operated at increased temperatures.

Another metal layer can additionally be applied to the layered composite material according to the invention as a run-in layer which makes it easy to run in the sliding element. Preferred run-in layers are indium, zinc, tin, indium alloy, zinc alloy, tin alloy layers, in particular zinc, bright tin and indium layers.

The layer thickness of the run-in layer is preferably 2-15 μm, in particular 3-6 μm, depending on the wear resistance of the run-in layer and the intended use of the sliding element.

In a preferred embodiment of the invention, the layered composite material consists of the base layer, optionally one or more metallic diffusion-barrier layer(s) and the sliding layer or of the base layer, optionally one or more metallic diffusion-barrier layer(s), the sliding layer and the run-in layer.

To produce the layered composite material according to the invention, the sliding element, comprising the support and the base layer applied thereto as well as optionally a metallic diffusion-barrier layer, is introduced into an aqueous electrolyte, connected as cathode and the above-described sliding layer containing lubricant particles is electrodeposited on the base layer.

By an electrolyte is meant within the meaning of the invention an aqueous solution, the electrical conductivity of which results from electrolytic dissociation of the electrolyte additives into ions. The electrolyte contains tin ions and optionally further metal ions for forming a tin alloy and, in addition, the usual electrolyte additives known to a person skilled in the art, such as for example acids and salts, as well as water as the remainder.

The electrolyte preferably contains 5-100 g/l, in particular 5-50 g/l tin in ion form, for example added as tin(II)methane sulfonate, and optionally further metals in ion or salt form as alloy elements.

The solid lubricant particles and optionally hard-material particles can be kept in suspension, for example by stirring, during the electrodeposition. In a preferred embodiment, a wetting agent and a suspension stabilizer which act as aids for repressing an aggregation and cluster formation of the particles and making it easier to incorporate the particles into the sliding layer are additionally added to the electrolyte. Alkyl aryl ethers, in particular alkyl naphthyl ethers, have proved to be particularly favourable as wetting agents, and anionic surfactants, in particular ether sulfates, i.e. compounds which contain at least one ether group and at least one sulfate group, have proved particularly favourable as suspension stabilizers. The wetting agent is preferably present in a quantity of 8-120 ml/l, in particular 3-80 ml/l, relative to the total volume of the electrolyte. The suspension stabilizer is preferably present in a quantity of 0.3-50 ml/l, in particular 1-15 ml/l.

The quantity of solid lubricant particles and optionally hard-material particles which is contained in the electrolyte can be varied within wide ranges and, in addition to the proportion to be incorporated, is also dependent on the willingness of the respective particles to deposit. It has proved advantageous that in each case 10-100 g/l solid lubricant particles and hard-material particles are contained in the electrolyte. Particularly preferably in each case 20-50 g/l and most preferably in each case 30-35 g/l solid lubricant particles and hard-material particles are contained in the electrolyte.

In a preferred embodiment of the invention, an acid electrolyte is used, in particular with a pH of ≦3, preferably with a pH of 1-2. An electrolyte which contains one or more alkyl sulfonic acids, in particular with 1-4 C atoms, has proved to be particularly favourable. Methane sulfonic acid, ethane sulfonic acid, methane disulfonic acid and ethane disulfonic acid are preferred alkyl sulfonic acids, in particular methane sulfonic acid. It is further preferred that the electrolyte is free of cyanide, by which is meant within the meaning of the invention that the electrolyte contains less than 0.1 g/l cyanide ions. Less than 0.01 g/l cyanide ions is preferred.

Temperatures of the electrolyte of approximately 20-60° C. are suitable for the electrodeposition, wherein temperatures of 25-35° C. are preferred. As a rule, the deposition takes place at current densities of approximately 0.5-20 A/dm², wherein current densities of approximately 2-4 A/dm² are preferred.

The present invention furthermore relates to a layered composite material which can be obtained using the method according to the invention. The present invention further relates to the use of the layered composite material according to the invention for sliding bearings, in particular crankshaft bearings, camshaft bearings or connecting rod bearings for combustion engines.

The suitable, preferred and particularly preferred embodiments described for the layered composite material according to the invention are also suitable, preferred and particularly preferred for the method according to the invention and the use.

It is understood that the features named above and those still to be explained below can be used not only in the given combinations but also in other combinations or alone, without exceeding the scope of the present invention.

The following example illustrates the invention.

An aqueous electrolyte of the following composition is prepared:

| | | |
|---|---|---|
| Sn²⁺ content (added as tin(II)methane sulfonate) | 35 | g/l |
| graphite particles (particle size ≦10 μm) | 30 | g/l |
| tin(IV)sulfide particles (particle size ≦10 μm) | 30 | g/l |
| wetting agent (alkyl naphthyl ether) | 90 | ml/l |
| suspension stabilizer (ether sulfate) | 15 | ml/l |

The pH of the electrolyte is set to approximately 1.5 with methane sulfonic acid. A sliding bearing having a copper-nickel-silicon alloy as base layer and a nickel layer applied over same was introduced into the electrolyte, connected as cathode and the sliding bearing was coated at 30° C. for 9 minutes at a current density of 3.5 A/dm², wherein a layer thickness of 10 pm was deposited. The obtained layered composite material is shown in FIG. 2. The analysis revealed that the sliding layer contained 0.85 wt.-% tin(IV)sulfide particles and 1.3 wt.-% graphite particles.

For comparison, a pure tin layer was produced without solid particles using the same method.

Compared with a conventional sliding bearing coating made of tin with a sliding layer free of solid lubricant particles, the sliding bearing with tin(IV)sulfide particles and graphite particles displayed an improved sliding capacity (coefficient of friction 0.05 compared with 0.1 to 0.2 of the particle-free tin layer) and a clearly improved strength (Vickers hardness of 23 HV 0.01 compared with 8 HV 0.01 of the particle-free tin layer, determined with the Metallux device from Leica, test pressure 0.01 kiloponds), as well as a good wear resistance and low seizing tendency.

1. A sliding element, comprising: a base layer, applied to the surface of the sliding element, and made of an alloy containing copper or aluminium; and a sliding layer arranged above said based layer comprising 90-99.6 wt.-% tin or tin alloy having a tin proportion of more than 60 wt.-% and 0.2-6 wt.-% solid lubricant particles having a Mohs hardness of ≦3 and a particle size of ≦10 μm, wherein the solid lubricant particles are a combination of tin(IV)sulfide particles and graphite particles, of tin(IV)sulfide particles and molybdenum(IV)sulfide particles or of graphite particles and molybdenum(IV)sulfide particles.

2. The sliding element according to claim 1, wherein the sliding layer additionally contains 0.2-4 wt.-% hard-material particles having a Mohs hardness of ≧8 and a particle size of ≦5 μm.

3. The sliding element according to claim 1, wherein the sliding layer consists of 90-99.6 wt.-% tin or tin alloy having a tin proportion of more than 60 wt.-%, 0.2-6 wt.-% solid lubricant particles having a Mohs hardness of ≦3 and a particle size of ≦10 μm.

4. The sliding element according to claim 2, wherein the hard-material particles are selected from the group consisting of tungsten carbide, chromium carbide, aluminium oxide, silicon carbide, silicon nitride, cubic boron nitride, boron carbide and diamond.

5. The sliding element according to claim 1, wherein there is a metallic diffusion-barrier layer between base layer and sliding layer.

6. A method of making a sliding element, comprising applying a base layer, to the surface of the sliding element and introducing it, into an aqueous electrolyte which has a pH of ≦3 and contains tin ions, solid lubricant particles having a Mohs hardness of ≦3 and a particle size of ≦10 μm, wherein the solid lubricant particles are a combination of tin(IV)sulfide particles and graphite particles, of tin(IV)sulfide particles and molybdenum(IV)sulfide particles or of graphite particles and molybdenum(IV)sulfide particles and electrodepositing a
sliding layer at a temperature of the electrolyte of 20-60° C. and a current density of 0.5-20 A/dm².

7. The method according to claim 6, wherein the electrolyte contains at least an alkyl sulfonic acid, an alkyl aryl ether and an ether sulfate.

8. The sliding element of claim 1, comprising a bearing.

9. The sliding element according to claim 3, wherein the sliding layer includes 0.2-4 wt.-% hard-material particles having a Mohs hardness of ≧8 and a particle size of ≦5 μm.

10. The sliding element according to claim 5, including a metallic run-in layer is additionally applied to the sliding layer.

11. The method of claim 6, including applying a diffusion barrier layer on the base layer before electrodepositing the sliding layer.

12. The method of claim 6, including providing the electrolyte with hard-material particles having a Mohs hardness of ≧8 and a particle size of ≦5 μm.
